(19) United States
(12) Patent Application Publication
(10) Pub. No.: US 2014/0042664 A1
(43) Pub. Date: Feb. 13, 2014

(54) Non ionic groups of amphoteric polysaccharide linear or branched alkyl or acid and base distillation reservoir liquid or gas solidparticle and Nano particle dispersion and recovery basin in vacuum processing for Building Materials and High Wear-Heat Resistant Parts Brushes; Windings; Coils; Battery Cells; Brake Pads; Bushings; 2.5 Phase Extrusion Die Cast Molding; Refrigeration; and Spectrometry Processor

(71) Applicant: Robert Richard Matthews, Washington, DC (US)

(72) Inventor: Robert Richard Matthews, Washington, DC (US)

(21) Appl. No.: 13/594,592

(22) Filed: Aug. 24, 2012

Related U.S. Application Data
(63) Continuation-in-part of application No. 13/584,682, filed on Aug. 13, 2012, now abandoned.

(51) Int. Cl. B29C 43/00

(52) U.S. Cl. CPC B29C 43/003
USPC 264/219; 425/135

(57) ABSTRACT

The variable hydraulic preform slurry non ionic or electrolyte carbon extrusion high wear-heat resistant parts press is utilized to manufacture process specified scientific formula liquid or gas mechanically refined and nanoparticle dispersion with or without ionic suspension element 1—carbon nanofoam CNFs extrusion high wear-heat resistant parts electronic component composite coils, composite windings, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, electronic resistors, transformers, transducers, rectifiers, power supplies, heat sinks 2—carbon nanofoam CNFs extrusion high wear-heat resistant parts aerospace, automotive, and transportation brake calipers, rotors, pads, washers, spacers, bushings and 3—carbon nanofoam CNFs extrusion high wear-heat resistant parts precision casting molds for the manufacturing of highly pure metal, Super Alloy, acid solid, alkaline, glass, acrylic, halide, alkalide, or ceramics specializing in 2.5 phase die cast molding.

### DOMESTIC PRIORITY DATA

This is an application a continuation in part of preliminary amendment to specification application Ser. No. 13/584,682 Filing Date Aug. 13, 2012.

### BACKGROUND OF THE INVENTION

Global warming and growing concerns of Greenhouse gas emissions from our dependency on fossil fuels are creating real demand and awareness for an electric alternative to fossil fuel engines and expensive replacement parts. Few technological developments of collecting and manufacturing carbon nanofoam CNFs improve upon our existing technological structure. By applying scientific utilization of preform technology the Variable hydraulic preform slurry non ionic or electrolyte carbon nanofoam CNFs extrusion high wear-heat resistant parts press with manufactured or processed carbon nanofoam CNFs assembled resources we can now create the manufacture process of preform slurry non ionic or electrolyte carbon nanofoam CNFs extrusion high wear-heat resistant parts.

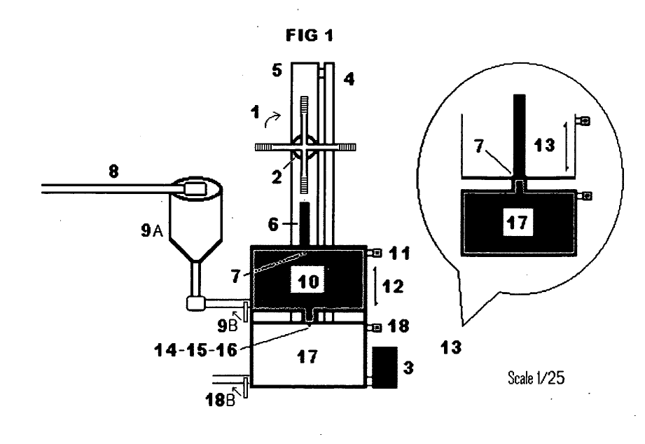

### BRIEF DESCRIPTION OF FIG. 1

FIG. 1 the Variable hydraulic preform slurry non ionic or electrolyte carbon nanofoam CNFs extrusion high wear-heat resistant parts press.

### DETAILED DESCRIPTION OF FIG. 1

Variable hydraulic preform slurry non ionic or electrolyte carbon extrusion high wear-heat resistant parts press 1—Hydraulic control wheel 2—Electronic servo 3—Hydraulic pump 4—Hydraulic pipe 5—Hydraulic actuator 6—Hydraulic tool steel arm 7—Slurry carbon tool steel press plate 8—Slurry carbon tool steel line in 9A—Gravity feed tool steel collector 9B—Tool steel release portal control 10—Slurry carbon tool steel reservoir 11—Slurry carbon reservoir regulated tool steel waste filter 12—Slurry carbon tool steel reservoir expanded 13—Slurry carbon tool steel reservoir contracted 14—Slurry carbon reservoir brass-tool steel aperture 15—Tool steel extrusion die cast design brass-tool steel fitting 16—Tool steel electronic servo or manual stop control release pull pin 17—Tool steel extrusion die cast design internal cavity 18—Tool steel extrusion die cast design internal cavity regulator waste filter and 18B—Tool steel vacuum release portal control.

### BRIEF SUMMARY OF THE INVENTION

Scientific utilization of preform technology the Variable hydraulic preform slurry non ionic or electrolyte carbon nanofoam CNFs extrusion high wear-heat resistant parts press FIG. 1 with manufactured or processed carbon nanofoam CNFs available resources enables the manufacture process of high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts, aerospace, automotive, transportation brake calipers, rotors, pads, washers, spacers, bushings, and precision casting molds for the manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions for each A and B specification part.

### DETAILED DESCRIPTION OF THE INVENTION

The Variable hydraulic preform slurry non ionic or electrolyte extrusion allotropes of carbon atomic number 6 symbol C herein referred to as preform slurry non ionic or electrolyte carbon and carbon nanofoam CNFs high wear-heat resistant parts press the center of this utility patent application specification manufacture process of specified scientific formula liquid or gas mechanically refined and nanoparticle dispersion preform slurry non ionic or electrolyte carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 46 elements and/or specification 47 alloys manufactured 1. preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 2. preform slurry non ionic or electrolyte carbon nanofoam CNFs extrusion high wear-heat resistant parts aerospace, automotive, and transportation brake calipers, rotors, pads, washers, spacers, and bushings 3. preform slurry non ionic or electrolyte carbon nanofoam CNFs extrusion high wear-heat resistant parts precision casting molds for the manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions for each A and B specification part.

Distillation Reservoir and Recovery Basin Made From Super Alloy and/or Ceramic with Variable Hydraulic Press Plate 1.0 to 2.0 phase extrusions polarized extrusion glass and acrylic or Mechanically Refined or Molten Highly Pure Metal, Super Alloy including Carbon, Carbon Nanofoam CNFs, Alternate Carbon Nano Foam CNFs Inductor, Silicate Mineral, Glass, Acrylic, Polymer Resin, Alumina Silica, Acid Solid, Impedance Matching Ceramic Red Brick Insulator, Molybdenum, Ceramic Zirconia, Ceramic Silica, Ceramic Clay, Calcium Carbonate, Alkaline, Minerals, including Ionic Suspension Elements and Ceramic Silicate Mineral Insulator for specification 46 elements Highly Pure Metal, specification 47 alloys Distillation reservoir Halogen Gas, Ammonia Gas From Nitrogen and Hydrogen, and Antimony Gas suspended elements mechanically refined and nanoparticle distillation Carbon Nanofoam CNFs, Alternate Carbon Nanofoam CNFs Inductor, Alumina, Nano alumina, Lead, Antimonide, Lithium, Nickel, Cadmium, Magnesium, Halide, and Alkalide. Processing and/or Four Pours 2.5 phase extrusions or preform slurry non ionic or electrolyte. Both Processes Molten Pours and Variable hydraulic preform slurry non ionic or electrolyte Press in Vacuum Control Room Scientific Principle of Distillation Ordinary Atmospheric Pressure less than Ordinary Atmospheric Pressure Catalyst Gases Other specification 46 elements Argon, Carbon Monoxide, and Carbon Dioxide mechanically refined or nanoparticle suspension catalyst Greater or Lesser Than Ordinary Atmospheric Pressure, Super Alloy Super Cooling Refrigeration And Super Alloy Venturi Curvical or Linear Expression Comprising a Scientific Aperture, a Divergence Measured in Angulation, and a Scientific Aperture Diffusion Gaseous Particle Accelerator With Super Cooling Refrigeration Deceleration with or without nanoparticle synthesizing Laser Ablation and Multi Waveform Ablation X, Y, And Z Fields and Fractional Vacuum Distillation Gaseous and/or Positive and Negative Ionic Charges Recovery and Super Alloy, Ceramic Zirconium, Ceramic Molybdenum, Ceramic Impedance Matching Red Brick Clay Insulator and/or Ceramic Silica Distillation reservoir with Variable Hydraulic Press Plate Expanded and Contracted Greater or Lesser Than Ordinary Atmospheric Pressure Distillation Recovery Fractional Vacuum Distillation Gaseous and/or Positive Distillation and Variable Hydraulic Press Plate Expanded and Contracted Greater or Lesser Than Ordinary Atmospheric Pressure Distillation Recovery Allotropes of 6-C-Carbon, Solid, and Liquid Chemical Non ionic Groups of Amphoteric Polysaccharide Linear or Branched Alkyl Compounds or Electrolytes and/or Liquid Ions and/or Ionic Melts and/or Fused and/or Acid and Bases Catalyst and/or Catalyst Slurry Reservoir 6-C-Allotropes of Carbon and Liquid and/or Liquid Vapours and/or Gaseous Electrolyte Catalyst Acids and Solid Materials Carbon, Carbon Nanofoam CNFs, Alternate Carbon Nano Foam CNFs Inductor, Silicate Mineral, Silica Alumina, Acid Solid, Impedance Matching Ceramic Red Brick Insulator, Molybdenum, Ceramic Clay, Calcium Carbonate, Ceramic Zirconia, Silicate Mineral, and Minerals for Building Materials Preform Modular alkalines, clays, and sands for fine concrete, mortar, bricks, tiles, and High Wear-Heat Resistant Parts Brushes, Windings, Coils, Battery Cells, Electronic Resistors, Capacitors, Brake Pads, Washers, Spacers, Bushings, Drawn, Annealing, Spun, Coils, Windings, Wire, Woven Textile Mesh, Shielding, And 2.5 phase extrusions Die Cast Molding. Supplemental Super Alloy Super Cooling Refrigeration And Super Alloy Venturi Curvical or Linear Expression Comprising a Scientific Aperture, a Divergence Measured in Angulation, and a Scientific Aperture Diffusion Carbon Dioxide CO2 Gaseous Particle Accelerator With Super Cooling Refrigeration Deceleration temperature to less than −109 degrees Fahrenheit or −78.5 degrees Celsius Carbon Dioxide CO2 sublimated frozen gas Supercooling Super Alloy or Super Alloy Venturi.

Self-contained Carbon Dioxide CO2 Refrigeration unit used for commercial or residential service operates in a complete vacuum with vacuum pump drawing Carbon Dioxide CO2 gas through insulated Super Alloy feeder tubes in a parallel circuit to separate Super Alloy Venturi Curvical or Linear Expression Comprising a Scientific Aperture, a Divergence Measured in Angulation, and a Scientific Aperture Diffusion Carbon Dioxide CO2 Gaseous Particle Accelerator With Super Cooling Refrigeration Deceleration temperature to less than −109 degrees Fahrenheit or −78.5 degrees Celsius Carbon Dioxide CO2 sublimated frozen gas is then passed over Super Alloy and through cooling fan.

Distillation and Recovery Basin Variable Hydraulic Press Plate Mold and Carbon Nanofoam CNFs Mold with Pour Aperture located in the center and hydraulic cylinder located on the right Expanded and Contracted for Molten Pouring Highly Pure Metal, Super Alloy including Carbon Nanofoam CNFs, and/or Ceramic for 1.0, and 2.0 phase extrusion Plates, Sheets, Foil, and Leaf Central Processing Unit CPU processor, relay, or switch series or parallel circuit and Battery Cell series or parallel circuit rated conductive Both Having Highly Pure Metal, Super Alloy including Carbon Nanofoam CNfs 1.0 and 2.0 phase extrusion Plates, Sheets, Foil, and Leaf Conductive Super Carbon Alloy Carbon Nanofoam CNFs, Nickel, Cadmium, Lithium, Lead, Antimonide, Halide, Alkalide, Ceramic Silicate Mineral Insulator, and Ceramic Alumina Silica Carbon Nanofoam CNFs.

Manufacture process of 2.5 phase extrusions Die Cast Molding for Precision Casting of Highly Pure Metal, Super Alloy including Carbon Nanofoam CNFs, and/or Ceramic. The Highly Pure Metal, Super Alloy including Carbon Nanofoam CNFs, and/or Ceramic is a layered greater than 0% to less than 100% highly Pure Metal or Super Alloy including Carbon Nanofoam CNFs and greater than 0% to less than 100% Other Metal, Super Alloy including Carbon Nanofoam CNFs or Ceramic part that is created by pouring molten metal or ceramic into a cast mold over a process of 2.5 phase extrusions that create six molded casts for each designed master tool steel part that is manually machined and manufactured named Part X external layer Highly Pure Metal or Super Alloy including Carbon Nanofoam CNFs and Part Z the internal layer other Highly Pure Metal, Super Alloy including Carbon Nanofoam CNFs or Ceramic Insulator.

Manufactured process of 2.5 phase extrusions Die Cast Molding for Precision Casting of Super Alloy and Ceramic ultimately create a single part identical to the master designed and machine manufactured part with the exception to the chemical element is now a Super Alloy or Super Alloy Ceramic that is layered greater than 0% to less than 100% highly Pure Metal or Super Alloy including Carbon Nanofoam CNFs and greater than 0% to less than 100% Other Highly Pure Metal, Super Alloy including Carbon Nanofoam CNFs and/or Ceramic. Processing molded halves sequence 1 to 9 of Manufacture process of 2.5 phase extrusions Die Cast Molding For Precision Casting of Highly Pure Metal, Super Alloy including Carbon Nanofoam CNFs, and/or Ceramic Part X and Part Z side profile not shown here of casting for Part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 and filled with molten Highly Pure Metal or Super Alloy including Carbon Nanofoam CNFs sequence 9.

The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.

The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten Highly Pure Metal or Super Alloy including Carbon Nanofoam CNFs fills. After the poured molten Highly Pure Metal or Super Alloy including Carbon Nanofoam CNFs cools then both extruded halves are removed and stored. The remainder halves with Highly Pure Metal or Super Alloy including Carbon Nanofoam CNFs are then joined and prepared for a second molten fill of greater than 0% to less than 100% Highly Pure Metal, Super Alloy including Carbon Nanofoam CNFs, and/or Ceramic.

After the fill is cooled the whole part is removed from the cast halves and is inspected, deburred, and/or finished.

The variable hydraulic preform slurry non ionic or electrolyte carbon extrusion high wear-heat resistant parts press FIG. 1 numbers 1 to 18. The 1—Hydraulic control wheel is connected to the 2—Electronic servo and allows the operator to expand and contract 7—Slurry carbon tool steel press plate primarily to expand the 10—Slurry carbon tool steel reservoir by moving the 1—Hydraulic control wheel in a fully counter clockwise fashion. This allows the operator to initiate a separate machine to pump Slurry carbon into the 8—Slurry carbon tool steel line in, subsequently to the 9—Gravity feed collector line out and finally to the 10—Slurry carbon tool steel reservoir. Slurry carbon is defined here as specified scientific formula liquid or gas mechanically refined and nanoparticle dispersion preform slurry non ionic or electrolyte carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 46 elements and/or specification 47 alloys manufactured preform slurry non ionic or electrolyte carbon nanofoam CNFs extrusion high wear-heat resistant parts. After the 10—Slurry carbon tool steel reservoir is filled the operator can electronically disengage or manually remove the manual stop control release pull pin. The operator then closes the 9B—Tool steel control to prepare for the extrusion. The operator would proceed by rotating the 1—Hydraulic control wheel in a clockwise fashion contracting the 7—Slurry carbon tool steel press plate and forcing the Slurry carbon comprised of carbon nanofoam CNFs slurry formula into the 17—Tool steel extrusion die cast design internal cavity. The specified amount of Slurry carbon is compressed to preform slurry non ionic or electrolyte carbon nanofoam CNFs extrusion specification pressure measured in millibars Mb until the specified Slurry carbon required to fill the 17—Tool steel extrusion die cast design internal cavity has been reached. The 1—Hydraulic control wheel is then locked until the 17—Tool steel extrusion die cast design internal cavity has been removed.

The 2—Electronic servo sends an electrical signal to the 3—Hydraulic pump of the 7—Slurry carbon tool steel press plate position that is calibrated to the 1—Hydraulic control wheel.

The 3—Hydraulic pump receives an electrical signal from the 2—Electronic servo of the 7—Slurry carbon tool steel press plate position that is calibrated to the 1—Hydraulic control wheel. The 3—Hydraulic pump pumps fluids to the 4—Hydraulic pipe.

The 4—Hydraulic pipe receives fluids from the 3—Hydraulic pump and conveys the fluids to the 5—Hydraulic actuator.

The 5—Hydraulic actuator receives fluids from the 4—Hydraulic pipe and the force from the fluids is transferred through the actuator as vertical up-and-down movement to an affixed 6—Hydraulic arm.

The 6—Hydraulic arm moves vertically up-and-down and forces the 7—Slurry carbon tool steel press plate to expand and contract.

The 7—Slurry carbon tool steel press plate is forced by the 6—Hydraulic arm to expand and contract.

The 8—Slurry carbon tool steel line in receives Slurry carbon from an external pump and conveys them to the 9A—Gravity feed tool steel collector. The 8—Slurry carbon tool steel line in can be ionic process tool steel interface positive or negative electrode electronically charged Slurry carbon for enhanced formulation.

The 9A—Gravity feed tool steel collector receives Slurry carbon from the 8—Slurry carbon tool steel line in and conveys them to the 10—Slurry carbon tool steel reservoir.

The 10—Slurry carbon tool steel reservoir receives Slurry carbon from the 9A—Gravity feed tool steel collector line out.

After the 10—Slurry carbon tool steel reservoir is filled the 9B—Tool steel control is utilized to close the opening to prepare for the extrusion and may be provisionally locked and stopped at any position.

The 11—Slurry carbon reservoir regulated tool steel waste filter removes waste from the 10—Slurry carbon tool steel reservoir while it is being filled with Slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system.

The 12—Slurry carbon reservoir expanded.

The 13—Slurry carbon reservoir contracted.

The 14—Slurry carbon reservoir brass or tool steel aperture and 15—Tool steel extrusion die cast design brass or tool steel fitting connects directly and conveys Slurry carbon to the 17—Tool steel extrusion die cast design internal cavity. The 18—Tool steel extrusion die cast design internal cavity regulator waste filter and 18B—Tool steel vacuum release control and portal works in unison with the press plate drawing expanding and contracting Slurry carbon removing waste from the 17—Tool steel extrusion die cast design internal cavity while it is being filled with Slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system.

The 17—Tool steel extrusion die cast internal cavity is designed as a tool steel extrusion die cast mold for each carbon nanofoam CNFs part comprised of two master extrusion tool steel halves. This is accomplished by first utilizing engineering drafting and computer aided design with the most advanced tool steel part manufacture process and tool steel part machining techniques and/or by utilizing replacement ceramic molds specification number 27 to supplement the development of extrusion die cast master design manufacture process with high purity tool steel die cast extrusion molds.

Carbon nanofoam CNFs brake pads, electronic brushes and parts require two master extrusion tool steel mold halves for each specification part. Carbon Nanofoam CNFs parts precision casting molds requires a minimum two and a maximum of six master extrusion tool steel mold halves for each specification part.

Carbon nanofoam CNFs parts precision casting molds are utilized to manufacture highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions and six master carbon nanofoam CNFs mold halves per specification part.

The manufacture process of 2.5 phase extrusions and die cast design for highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator requires six master extrusion tool steel halves for each six reciprocal carbon nanofoam CNFs master precision casting molds parts allowing two A and B highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator to be combined. The 0.5 phase extrusion equals two die cast mold halves both equal to or less than one half 0.5 phase extrusion molten pour.

The utility patent application specification concrete control room and monitoring station manufacturing in a complete vacuum and may supply rich oxygen from capillary feeders at varying points to the specified highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator part molten fill A and B fills four pours. The carbon nanofoam CNFs half shell or 0.5 phase extrusion are designed and utilized for state of the art manufacture process when combining highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator in combination of layered foundry fills, parts may be sprayed and dipped non conductive adhesives insulator films, and all waste gases are processed to flu gas detoxification system. The highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator is a layered greater than 0% to less than 100% alloy component A and greater than 0% to less than 100% alloy component B part that is created in combination of layered foundry fills by utilizing six master carbon nanofoam CNFs parts precision casting molds per specification part by pouring molten fill as a layered alloying component highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator four molten metal or other fill pours equal to 2.5 phase extrusions.

The highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator is a layered greater than 0% to less than 100% highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator A component part, and greater than 0% to less than 100% highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator B component part created in combination of layered fills of six master carbon nanofoam CNFs extrusion die cast mold halves equal to 2.5 phase extrusions.

Super carbon alloy is defined as carbon nanofoam CNFs sintered and/or smeltered foundry manufacture process of combined highly pure metal, Super Alloy, and/or element. The pre and post pour technological standard is accomplished with the utility patent application specification concrete control room and monitoring station manufacturing in a complete vacuum and may supply rich oxygen from capillary feeders at varying points and all waste gases are processed to flu gas detoxification system and includes nitrate, nitride, anodize, and benzotriazole, methyl, tolyltriazole, sodium chemical pre and post foundry treatment submersion bath flake and prill anticorrosive purification solution washing and screening table for the manufacture of copper and metals. Hot smelters prepare iron, manganese, lithium, cadmium, lead, nickel, copper, zinc, zirconium, aluminum, titanium, molybdenum, tungsten, or metal for die cast pours and are also utilized for layered foundry fills die cast pours of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator. All mechanically refined metal ore may be sintered and/or smeltered element additive alloyed carbon nanofoam CNFs, tolyltriadole, sodium, benzotriadole, methyl, ammoniate, galvanize, anodize, nitrate, molybdenum, chromium, chromoloy, nitride, hydrochloric acid or combined alloyed sintered and/or smeltered highly pure metal, Super Alloy, alkaline, nonconductive zirconia, or impedance matching load or signal ceramic red brick clay insulator.

All metal ore may be sintered and/or smeltered for homogenization and specific melting point measured in degrees Celsius.

Finely screened grit size mechanically refined copper ore may be pre molten metal chemically treated manufacture process with tolyltriazole, sodium and benzotriazole, methyl, flake, and prill washing and screening table technique and chemical submersion bath for highly pure copper, brass, and bronze alloy anticorrosion purification process sequence.

Replacement ceramic cast 2.5 phase extrusions die cast molding for Super Alloy. The Super Alloy is a layered greater than 0% to less than 100% highly pure metal or Super Alloy and greater than 0% to less than 100% highly pure metal or Super Alloy part that is created by pouring molten metal into a cast mold over a process of 2.5 phase extrusions that create four molded casts for each designed master steel part that is manually machined and manufactured named part X the external layer highly pure metal or Super Alloy and part Z the internal layer highly pure metal or Super Alloy.

This replacement mold application is for the manufactured process of 2.5 phase extrusions that creates a single part identical to the master designed and machined manufactured part. The new part chemical element becomes a Super Alloy that is layered greater than 0% to less than 100% highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator and greater than 0% to less than 100% highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator.

The manufacture process begins by a designed and machined manufactured master part named part X. The master part X is used to create two external cast halves. This is accomplished by casting the master part X into the center of two ceramic molded halves with newly poured ceramic slip and then may be placed in a cool damp room and receive finish application with a wet sponge. After the ceramic cast dries the master part X is removed and the two ceramic molded halves are ignited and cured 3 hours in a kiln at 2000 degrees Fahrenheit or 12 hour interval day at 2000 degrees Fahrenheit.

The second master part named part Z is designed and machined manufactured greater than 0% to less than 100% less than tolerances that of the master part X or the external cast halves. The master part Z is used to create two internal cast halves. This is accomplished by casting the master part Z into the center of two ceramic molded halves with newly poured ceramic slip and then may be placed in a cool damp room and receive finish application with a wet sponge. After the ceramic cast dries the master part Z is removed and the two ceramic molded halves are ignited and cured 3 hours in a kiln at 2000 degrees Fahrenheit or 12 hour interval day at 2000 degrees Fahrenheit. After the two ceramic cast halves cool they are used separately to make two reciprocal extrusion halves by pouring ceramic slip into the recesses and joining both halves with new cast covers to dry.

The external tolerances of all of the four cast covers X and Z are identical opposing so that X and Z halves can be joined and prepared for two separate halves molten highly pure metal or Super Alloy fills. After the poured molten highly pure metal or Super Alloy cools both extruded halves are removed and stored. The remainder halves with highly pure metal or Super Alloy fills are then joined and prepared for a second molten fill of greater than 0% to less than 100% highly pure metal or Super Alloy.

After the highly pure metal or Super Alloy is cooled the whole part is removed from the cast halves and is inspected, deburred, and finished.

The 14—Slurry carbon reservoir brass or tool steel aperture conveys Slurry carbon Nanofoam CNFs to the 17—Tool steel extrusion die cast design internal cavity. Carbon nanofoam CNFs slurry electrolyte particle samples are taken and photo spectrometry analyzed measured in nanometers Nm to enhance slurry formula.

The 16—Tool steel electronic servo or manual stop control release pull pin can be electronically disengaged or manually removed after the 10—Slurry carbon tool steel reservoir is filled to begin the Slurry carbon extrusion.

The 18—Tool steel extrusion die cast design internal cavity regulator waste filter removes waste from the 17—Tool steel extrusion die cast design internal cavity while it is being filled with Slurry carbon. The 18—Tool steel extrusion die cast design internal cavity regulator waste filter and 18B—Tool steel vacuum release control with processing may utilize an external vacuum pump for required specifications specified scientific formula liquid or gas mechanically refined and nanoparticle dispersion preform slurry non ionic or electrolyte carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 46 elements and/or specification 47 alloys.

The manufacture process of preform slurry non ionic or electrolyte carbon nanofoam CNFs extrusion high wear-heat resistant part is to cool it and/or dry it at room temperature in degrees Celsius or cure the part in a furnace typically for 5 to 20 minutes from 1076 degrees Fahrenheit to 3230 degrees Fahrenheit.

Preform slurry non ionic or electrolyte making of four sections 1. preform slurry non ionic or electrolyte carbon nanofoam CNFs extrusion high wear-heat resistant part 2. preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts 3. preform slurry non ionic or electrolyte carbon nanofoam CNFs extrusion high wear-heat resistant parts aerospace, automotive, and transportation brake calipers, rotors, pads, washers, spacers, and bushings 4. preform slurry non ionic or electrolyte carbon nanofoam CNFs extrusion high wear-heat resistant parts precision casting molds for the manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions six master preform slurry non ionic or electrolyte carbon nanofoam CNFs extrusion high wear-heat resistant parts precision casting molds. All 2.5 phase extrusions and half shell castings are processed utility patent application specification concrete control room and monitoring station manufacturing in a complete vacuum and may supply rich oxygen from capillary feeders at varying points to molten elements in crucibles, and extrusion molds parts may be sprayed and dipped non conductive adhesives insulator films and all waste gases are processed to flu gas detoxification system.

Preform slurry non ionic or electrolyte carbon nanofoam CNFs made by the Variable hydraulic preform slurry non ionic or electrolyte carbon nanofoam CNFs extrusion high wear-heat resistant parts press FIG. 1 numbers 1 to 18. Number 5. The Variable hydraulic preform slurry non ionic or electrolyte carbon nanofoam CNFs extrusion high wear-heat resistant parts press with FIG. 1 numbers 1 to 18 specific components that conform to specified requirements to unique American Society for Testing and Materials International Standards Worldwide Identifiers. The Variable hydraulic preform slurry non ionic or electrolyte carbon nanofoam CNFs extrusion high wear-heat resistant parts press, the center of this utility patent application specification slurry formula in three scientific forms of Solids 6, Liquids 7 and Gases 8 Noble gas argon or element gaseous specified scientific formula liquid or gas mechanically refined and nanoparticle dispersion preform slurry non ionic or electrolyte carbon nanofoam CNFs solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 46 elements and/or specification 47 alloys manufactured preform slurry non ionic or electrolyte carbon nanofoam CNFs extrusion high wear-heat resistant parts.

Utility patent application specification concrete control room and monitoring station manufacturing in a complete vacuum and may supply rich oxygen from capillary feeders at varying points to utility patent application specification for with die cast mold extrusion or printing hot smelters casting manufacturing of specified highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator including six master extrusion halves 2.5 phase extrusions per specification part molten foundry fill four pours and the manufacture process or assembly for each specification component or part thereof and all waste gases are processed to flu gas detoxification system.

Utility patent application specification concrete control room and monitoring station manufacturing in a complete vacuum and may supply rich oxygen from capillary feeders at varying points to utility patent application specification manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component, or other metal drawing and annealing process for Wire, spun Cable, Rebar textile Mesh, with or without woven textile synthetic resin or natural fibers unit of measurement in gage Rebar Cable or Manufacture Process Connector System, cable connectors, powders, nitrate hardened or non hardened Nitride Steel Grit unit of measurement in mesh or grit size and manufacturing of carbon nanofoam CNFs Super Alloy Super Carbon Alloy.

Utility patent application specification concrete control room and monitoring station manufacturing in a complete vacuum and may supply rich oxygen from capillary feeders at varying points to utility patent application specification 2.5 phase extrusions manufacturing of highly pure metal or Super Alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system.

Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system.

Utility patent application specification concrete control room and monitoring station manufacturing in a complete vacuum and may supply rich oxygen from capillary feeders at varying points to mechanically refined metal ore sintered and smeltered non metallic additive carbon nanofoam CNFs alloyed Super Carbon Alloy, steel Super Carbon Steel, tungsten Super Carbon Tungsten, or additive sintered and smeltered molybdenum for homogenization steel Molybdenum Steel, or tungsten Molybdenum Tungsten and all waste gases are processed to flu gas detoxification system.

Utility patent application specification manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions or half shell casted composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor, or three sides zircon cutting tools, or two sides continuous for drill bits half shell casted tools measured in gage.

Utility patent application specification manufacturing of highly pure metal or Super Alloy tool steel tungsten forge die cast tool, crimping tool for Rebar Cable or Manufacture Process Connector System, specific tool steel parts that conform to specified requirements to unique American Society for Testing and Materials International Standards Worldwide Identifiers the Variable hydraulic preform slurry non ionic or electrolyte carbon nanofoam CNFs extrusion high wear-heat resistant parts press FIG. 1 numbers 1 to 18 and tool steel tungsten die cast extrusion molds for with manufacturing highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor.

Utility patent application specification manufacture process of replacement ceramic precision casting molds specification number 27 for with manufacturing highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor.

Utility patent application specification manufacture process of preform slurry non ionic or electrolyte carbon nanofoam CNFs with or without ionic suspension element specification 46 elements or specification 47 alloys extrusion or casted highly pure metal, Super Alloy, carbon nanofoam CNFs with or without ionic suspension element specification 46 elements or specification 47 alloys, and alkaline, glass, acrylic, halide, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink series or parallel circuit two positive and negative +/− terminals measured in Volts symbol V, or of preform slurry non ionic or electrolyte alternate carbon nanofoam CNFs inductor extrusion, or casted highly pure metal, Super Alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground in series or parallel circuit two negative −/− terminals measure in Ohms symbol Ω of inductor, antinode coupler, and ground or two positive and negative +/− terminals measured in Volts symbol V. All electronic parts two sides casted conductive plate, sheet, foil, or leaf highly pure metal, Super Alloy, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, Super Alloy, and/or alkaline, glass, acrylic, halide, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, Super Alloy, and/or alkaline, glass, acrylic, halide, or alkalide, plate, sheet, foil, or leaf casted in series or parallel circuit and two positive and negative +/− terminals measured in Volts symbol V or two negative −/− terminals measured in Ohms symbol Ω to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, Super Alloy, and/or alkaline, glass, acrylic, halide, or alkalide, plate, sheet, foil, or leaf casted in series or parallel circuit and two positive and negative +/− terminals measured in Volts symbol V or two negative −/− terminals measured in Ohms symbol Ω to antinode coupler preform slurry non ionic or electrolyte casted ionic suspension element carbon nanofoam CNFs battery cell outstanding one or two sides plate, sheet, foil, or leaf casted conductive highly pure metal, Super Alloy, or alkalide in series or parallel circuit and two positive and negative +/− terminals measured in Volts symbol V or two negative −/− terminals measured in Ohms symbol Ω to antinode coupler or electronic parts requires one, or two, or more brushes in even intervals and two or more inductors and antinode couplers with one or two sides conductive plate, sheet, foil, or leaf casted highly pure metal, Super Alloy, or alkalide in series or parallel circuit and two positive and negative +/− terminals measured in Volts symbol V or two negative −/− terminals measured in Ohms symbol Ω to antinode coupler.

Battery crucible casted or 2.5 phase extrusions highly pure metal or Super Alloy battery cells layered, spaced and casted conductive in series or parallel circuit even or odd interval number combinations varying complex, battery cells highly pure acid solid chemical and/or highly pure chemical alkali solid complex, crucible casted conductive or 2.5 phase extrusions highly pure metal or Super Alloy layered and interval spaced conductive in series or parallel circuit. Battery with or without lightweight super impregnated suspension element Halogen, Antimony, or Chemical Element-gases ammonia, from nitrogen, and hydrogen, hydrochloric acid with or without ionic suspension element carbon nanofoam CNFs, Nano alumina, and ionic suspension element specification 46 highly pure metals or ionic suspension element specification 47 Super Alloys and/or Alumina, crucible casted conductive or 2.5 phase extrusions highly pure metal or Super Alloy layered, and interval spaced series or parallel circuit and/or complex, crucible casted conductive or 2.5 phase extrusions Variable hydraulic preform slurry non ionic silica alumina carbon nanofoam CNFs extrusion high wear-heat compression resistant light weight battery cells. Highly pure alkali silica, alumina, Nano alumina, or elements lithium, cadmium, nickel, lead, copper, specification 46 elements or specification 47 alloys. One by one each battery cell crucible casted non conductive or submersion bath sealed Thermoplastic resin composition and its synthetic resin composite polymer insulation control room vacuum protocol manufacture process. Motor Frame protected of four woven synthetic resin fiber textile mesh, silica resin fiber heat resistant textile mesh, Variable hydraulic preform slurry non ionic silica alumina carbon nanofoam CNFs extrusion high wear-heat compression resistant light weight insulator, and/or high tensile strength shielded textile Super Carbon Alloy. One by one each battery cell crucible casted or submersion bath sealed Thermoplastic resin composition and its synthetic resin composite polymer insulator control room vacuum protocol manufacture process. All four conductive or non conductive heat-wear high tensile strength and compression resistant insulators are designed and built in Monocomb and corrugated—compartmented composite combinations Thermoplastic sealed, layered or woven shielded.

Motor crucible casted or 2.5 phase extrusions highly pure metal or Super Alloy composite coils, composite windings, and copper wire drawing, annealing, and spun coils or other highly pure metal including highly pure metal or Super Alloy drawing and annealing process for wire. Motors composite coils, composite windings usually copper or Super Alloy includes continuous or numeric interval spools shapes of rod, cylinder, sphere, rectangle, or square crucible casted or 2.5 phase extrusions. Motor electronic components brushes Carbon Nanofoam CNFs with or without ionic suspension elements each brush alternate carbon nanofoam inductors, and antinode coupler continuous or numeric ramps positive and negative terminal +/− measured in volts V and monitors positive and negative terminal +/− measured in volts V and negative and negative −/− terminals measure in Ohms symbol Ω of inductor, antinode coupler, and ground series or parallel circuit. Spun numeric wrapped copper or Super Carbon Copper Alloy wire are Thermoplastic dipped or woven protected synthetic resin fibers, silica woven resin fibers or high tensile strength Super Alloy carbon nanofoam CNFs shielding Motor frame protected of three woven synthetic resin fiber textile shielding, silica resin fiber high heat-resistant insulator textile shielding, and/or high tensile strength textile Super Carbon Alloy shielding. One by one all composite or wire Motor coils and windings are crucible casted or submersion bath sealed Thermoplastic resin composition and its synthetic resin composite polymer insulator control room vacuum protocol manufacture process. Three heat-wear high tensile strength and Variable hydraulic preform slurry non ionic silica alumina carbon nanofoam CNFs extrusion high wear-heat compression resistant light weight insulators are designed and built in Monocomb and corrugated—compartmented composite combinations Thermoplastic sealed, layered or woven shielded. Crucible casted or 2.5 phase extrusions motor casings, rods, bearings, housings, and assemblies are manufactured and assembled.

Spectrometry processor for commercial sale comprises scientific 10 inch camera spectrometry lens conveying light to specialized mirror and/or active chemical film and reflected onto red, green, and blue RGB scale trade name pixilated lenses conveying light to fiber optic cables conveying light to Central Processing Unit CPU processors electronic photo receptors frequency counters of red, green, or blue RGB scale signals output and/or Central Processing Unit CPU processors or red, green, and blue RGB scale signals output to Central Processing Unit CPU processors monitor and/or Central Processing Unit CPU processors super alloy rasterized of red, green, and blue RGB scale ink composite printed film.

Specification Periodic Table Element Groups Alkali Metals, Alkalide Earth Metals, Transition Metals, Other Metals, Metalloids, Non-Metals, Halogens, Noble Gases, and Rare Earth Element here in atomic number, element symbols, and names 3—Li—Lithium, 4—Be—Beryllium, 5—B Boron, 12—Mg—Magnesium, 13—Al—Aluminum, 21—Sc—Scandium, 22—Ti—Titanium, 23—V—Vanadium, 24—Cr—Chromium, 25—Mn—Manganese, 26—Fe—Iron, 27—Co—Cobalt, 28—Ni—Nickel, 29—Cu—Copper, 30—Zn—Zinc, 31—Ga—Gallium, 32—Ge—Germanium, 33—As—Arsenic, 37—Rb—Rubidium, 38—Sr—Strontium, 39—Y—Yttrium, 40—Zr—Zirconium, 41—Nb—Niobium, 42—Mo—Molybdenum, 43—Tc—Technetium, 44—Ru—Ruthenium, 45—Rh—Rhodium, 46—Pd—Palladium, 47—Ag—Silver, 48—Cd—Cadmium, 49—In—Indium, 50—Sn—Tin, 51—Sb—Antimony, 52—Te—Tellurium, 55—Cs—Cesium, 56—Ba—Barium, 57—La—Lanthanum, 58—Ce—Cerium, 59—Pr—Praseodymium, 60—Nd—Neodymium, 61—Pm—Promethium, 62—Sm—Samarium, 63—Eu—Europium, 64—Gd—Gadolinium, 65—Tb—Terbium, 66—Dy—Dysprosium, 67—Ho—Holmium, 68—Er—Erbium, 69—Tm—Thulium, 70—Yb—Ytterbium, 71—Lu—Lutetium, 72—Hf—Hafnium, 73—Ta—Tantalum, 74—W—Tungsten, 75—Re—Rhenium, 76—Os—Osmium, 77—Ir—Iridium, 78—Pt—Platinum, 79—Au—Gold, 80—Hg—Mercury, 81—Tl—Thallium, 82—Pb—Lead, 83—Bi—Bismuth, 84—Po—Polonium, 85—At—Astatine, 87—Fr—Francium, 88—Ra—Radium, 89—Ac—Actinium, 90—Th—Thorium, 91—Pa—Protactinium, 92—U—Uranium, 93—Np—Neptunium, 94—Pu—Plutonium, 95—Am—Americium, 96—Cm—Curium, 97—Bk—Berkelium, 98—Cf—Californium, 99—Es—Einsteinium, 100—Fm—Fermium, 101—Md—Mendelevium, 102—No—Nobelium, 103—Lr—Lawrencium, 104—Rf—Rutherfordium, 105—Db—Dubnium, 106—Sg—Seaborgium, 107—Bh—Bohrium, 108—Hs—Hassium, 109—Mt—Meitnerium, 110—Ds—Darmstadtium, 111—R9—Roentgenium, 112—Cn—Copernicium, 113—Uut—Ununtrium, 114—Uuq—Ununquadium, 115—Uup—Ununpentium, 116—Uuh—Ununhexium, 117—Uus—Ununseptium, and/or 118—Uuo—Ununoctium.

Specification Alloys metallurgy substances that are a mixture of two or more metals, or of a metal with a nonmetallic material not limited to Aluminum Alloys AA-8000 used for building wire, Al—Li aluminum, lithium, sometimes mercury, Alnico aluminum, nickel, copper, Duralumin copper, aluminum, Magnalium aluminum, 5% magnesium, Magnox magnesium oxide, aluminum, Nambe aluminum plus seven other unspecified metals, Silumin aluminum, silicon, and Zamak zinc, aluminum, magnesium, copper, Aluminum forms other complex alloys with magnesium, manganese, and platinum. Bismuth Alloys Wood's metal bismuth, lead, tin, cadmium, Rose metal bismuth, lead, tin, Field's metal, and Cerrobend. Cobalt Alloys Megallium, and Stellite cobalt, chromium, tungsten or molybdenum, carbon Talonite cobalt, chromium. Ultimet cobalt, chromium, nickel, molybdenum, iron, tungsten, and Vitallium. Copper Alloys Arsenical copper, Beryllium copper, beryllium, and Billon copper, silver. Brass copper, zinc, Calamine brass copper, zinc, Chinese silver copper, zinc, Dutch metal copper, zinc, Gilding metal copper, zinc, Muntz metal copper, zinc, Pinchbeck copper, zinc, Prince's metal copper, zinc, and Tombac copper, zinc. Bronze copper, tin, aluminum or other element, Aluminum bronze copper, aluminum, Arsenical bronze copper, arsenic, Bell metal copper, tin, Florentine bronze copper, aluminum or tin, Glucydur beryllium, copper, iron, Guanin likely a manganese bronze of copper, manganese, with iron sulfides and other sulfides, Gunmetal copper, tin, zinc, Phosphor bronze copper, tin and phosphorus, Ormolu Gilt Bronze copper, zinc, and Speculum metal copper, tin. Constantan copper, nickel, Copper-tungsten copper, tungsten, Corinthian bronze copper, gold, silver, Cunife copper, nickel, iron, Cupronickel copper, nickel, Cymbal alloys Bell metal copper, tin, Devarda's alloy copper, aluminum, zinc, Electrum copper, gold, silver, Hepatizon copper, gold, silver, Heusler alloy copper, manganese, tin, Manganin copper, manganese, nickel, Nickel silver copper, nickel, Nordic gold copper, aluminum, zinc, tin, Shakudo copper, gold, and Tumbaga copper, gold. Gallium Alloys Galinstan gallium, indium, tin. Gold Alloys Electrum gold, silver, copper, Tumbaga gold, copper, Rose gold, copper, and White gold, nickel, palladium, or platinum. Indium Alloys Field's metal indium, bismuth, tin. Iron or Ferrous Alloys Steel carbon Stainless steel chromium, nickel, AL-6XN, Alloy 20, Celestrium, Marine grade stainless, Martensitic stainless steel, and Surgical stainless steel chromium, molybdenum, nickel. Silicon steel silicon, Tool steel tungsten or manganese, Bulat steel, Chromoly chromium, molybdenum, Crucible steel, Damascus steel, HSLA steel, High speed steel, Maraging steel, Reynolds 531, and Wootz steel. Iron Anthracite iron carbon, Cast iron carbon, Pig iron carbon, and Wrought iron carbon. Fernico nickel, cobalt, Elinvar nickel, chromium, Invar nickel, Kovar cobalt, and Spiegeleisen manganese, carbon, silicon. Ferroalloys Ferroboron, Ferrochrome chromium, Ferromagnesium, Ferromanganese, Ferromolybdenum, Ferronickel, Ferrophosphorus, Ferrotitanium, Ferrovanadium, and Ferrosilicon. Lead Alloys Antimonial lead, antimony, Molybdochalkos lead, copper, Solder lead, tin, Terne lead, tin, and Type metal lead, tin, antimony. Magnesium Alloys Magnox magnesium, aluminum T—Mg—Al—Zn Bergman phase, and Elektron. Mercury Alloys Amalgam mercury and other metal except platinum. Nickel Alloys Alumel nickel, manganese, aluminum, silicon, Chromel nickel, chromium, Cupronickel nickel, bronze, copper, German silver nickel, copper, zinc, Hastelloy nickel, molybdenum, chromium, sometimes tungsten, Inconel nickel, chromium, iron, Monel metal copper, nickel, iron, manganese, Mu-metal nickel, iron, Ni—C nickel, carbon, Nichrome chromium, iron, nickel, Nicrosil nickel, chromium, silicon, magnesium, Nisil nickel, silicon, and Nitinol nickel, titanium, shape memory alloy. Potassium Alloys KLi potassium, lithium, and NaK sodium, potassium. Rare Earth Alloys Mischmetal various rare earths. Silver Alloys Argentium sterling silver, copper, germanium, Billon copper or copper bronze, sometimes with silver, Britannia silver, copper, Electrum silver, gold, Goloid silver, copper, gold, Platinum sterling silver, platinum, Shibuichi silver, copper, and Sterling silver, copper. Tin Alloys Britannium tin, copper, antimony, Pewter tin, lead, copper, and Solder tin, lead, antimony. Titanium Alloys Beta C titanium, vanadium, chromium, other metals, and 6al-4v titanium, aluminum, vanadium. Uranium Alloys Staballoy depleted uranium with titanium or molybdenum, and Uranium may also be alloyed with plutonium. Zinc Alloys Brass zinc, copper, and Zamak zinc, aluminum, magnesium, copper. Zirconium Alloys Zircaloy zirconium and tin, sometimes with niobium, chromium, iron, nickel.

1. Preform slurry non ionic or electrolyte carbon nanofoam CNFs made by the Variable hydraulic preform slurry non ionic or electrolyte carbon nanofoam CNFs extrusion high wear-heat resistant parts press FIG. 1 numbers 1 to 18. Number 5. The variable hydraulic preform slurry non ionic or electrolyte carbon nanofoam CNFs extrusion high wear-heat resistant parts Press with FIG. 1 numbers 1 to 18 specific components that conform to specified requirements to unique American Society for Testing and Materials International Standards Worldwide Identifiers. The variable hydraulic preform slurry non ionic or electrolyte carbon nanofoam CNFs extrusion high wear-heat resistant parts press, the center of this utility patent application specification slurry formula in three scientific forms of 6 Solids, 7 Liquids and 8 Gases Noble gas argon or element gaseous specified scientific formula liquid or gas mechanically refined and nanoparticle dispersion preform slurry non ionic or electrolyte carbon nanofoam CNFs extrusion solids, liquids, and/or gases, heated, chilled, or room temperature Chemical Non ionic Groups of Amphoteric Polysaccharide Linear or Branched Alkyl Compounds or electrolyte ionic melts, ionic fluids, and/or fused, and/or catalyst acid and bases, actual catalyst, and/or catalyst reservoir with or without ionic suspension element specification 46 elements and/or specification 47 alloys manufactured preform slurry non ionic or electrolyte carbon nanofoam CNFs extrusion high wear-heat resistant parts Preform slurry non ionic or electrolyte making of four sections Number 1. preform slurry non ionic or electrolyte carbon nanofoam CNFs extrusion high wear-heat resistant part Number 2. preform slurry non ionic or electrolyte carbon nanofoam CNFs extrusion high wear-heat resistant parts electronic component composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts Number 3. preform slurry non ionic or electrolyte carbon nanofoam CNFs extrusion high wear-heat resistant parts aerospace, automotive, and transportation brake calipers, rotors, pads, washers, spacers, and bushings Number 4. preform slurry non ionic or electrolyte carbon nanofoam CNFs extrusion high wear-heat resistant parts precision casting molds for the manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions six master preform slurry non ionic or electrolyte carbon nanofoam CNFs extrusion high wear-heat resistant parts precision casting molds. Slurry carbon tool steel line in can be ionic process tool steel interface positive or negative electrode electronically charged for enhanced formulation. Specified amount of Slurry carbon is compressed to preform slurry non ionic or electrolyte carbon nanofoam CNFs extrusion specification pressure measured in millibars Mb. Slurry carbon reservoir regulated tool steel waste filter removes waste from the Slurry carbon tool steel reservoir while it is being filled with Slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system. Tool steel extrusion die cast design internal cavity regulator waste filter and tool steel vacuum release control and portal works in unison with the press plate drawing expanding and contracting Slurry carbon removing waste from the tool steel extrusion die cast design internal cavity while it is being filled with Slurry carbon from common recovery distillation heated interface tool steel and thermometer gauge, ordinary atmospheric pressure, vacuum pump barometric pressure measured in millibars Mb, and fractional distillation all waste gases are processed to flu gas detoxification system. Distillation Reservoir and Recovery Basin Made From Super Alloy and/or Ceramic with Variable Hydraulic Press Plate 1.0 to 2.0 phase extrusions polarized extrusion glass and acrylic or Mechanically Refined or Molten Highly Pure Metal, Super Alloy including Carbon, Carbon Nanofoam CNFs, Alternate Carbon Nano Foam CNFs Inductor, Silicate Mineral, Glass, Acrylic, Polymer Resin, Alumina Silica, Acid Solid, Impedance Matching Ceramic Red Brick Insulator, Molybdenum, Ceramic Zirconia, Ceramic Silica, Ceramic Clay, Calcium Carbonate, Alkaline, Minerals, including Ionic Suspension Elements and Ceramic Silicate Mineral Insulator for specification 46 elements Highly Pure Metal, specification 47 alloys Distillation reservoir Halogen Gas, Ammonia Gas From Nitrogen and Hydrogen, and Antimony Gas suspended elements mechanically refined and nanoparticle distillation Carbon Nanofoam CNFs, Alternate Carbon Nanofoam CNFs Inductor, Alumina, Nano alumina, Lead, Antimonide, Lithium, Nickel, Cadmium, Magnesium, Halide, and Alkalide distillation Processing and/or Four Pours 2.5 phase extrusions or preform slurry non ionic or electrolyte. Both Processes Molten Pours and Variable hydraulic preform slurry non ionic or electrolyte Press in Vacuum Control Room Scientific Principle of Distillation Ordinary Atmospheric Pressure less than Ordinary Atmospheric Pressure Catalyst Gases Other specification 46 elements Argon, Carbon Monoxide, and Carbon Dioxide mechanically refined or nanoparticle suspension catalyst Greater or Lesser Than Ordinary Atmospheric Pressure, Super Alloy Super Cooling Refrigeration And Super Alloy Venturi Curvical or Linear Expression Comprising a Scientific Aperture, a Divergence Measured in Angulation, and a Scientific Aperture Diffusion Gaseous Particle Accelerator With Super Cooling Refrigeration Deceleration with or without nanoparticle synthesizing Laser Ablation and Multi Waveform Ablation X, Y, And Z Fields and Fractional Vacuum Distillation Gaseous and/or Positive and Negative Ionic Charges Recovery and Super Alloy, Ceramic Zirconium, Ceramic Molybdenum, Ceramic Impedance Matching Red Brick Clay Insulator and/or Ceramic Silica Distillation reservoir with Variable Hydraulic Press Plate Expanded and Contracted Greater or Lesser Than Ordinary Atmospheric Pressure Distillation Recovery Fractional Vacuum Distillation Gaseous and/or Positive Distillation and Variable Hydraulic Press Plate Expanded and Contracted Greater or Lesser Than Ordinary Atmospheric Pressure Distillation Recovery Allotropes of 6-C-Carbon, Solid, and Liquid Chemical Non ionic Groups of Amphoteric Polysaccharide Linear or Branched Alkyl Compounds or Electrolytes and/or Liquid Ions and/or Ionic Melts and/or Fused and/or Acid and Bases Catalyst and/or Catalyst Slurry Reservoir 6-C-Allotropes of Carbon and Liquid and/or Liquid Vapours and/or Gaseous Electrolyte Catalyst Acids and Solid Materials Carbon, Carbon Nanofoam CNFs, Alternate Carbon Nano Foam CNFs Inductor, Silicate Mineral, Silica Alumina, Acid Solid, Impedance Matching Ceramic Red Brick Insulator, Molybdenum, Ceramic Clay, Calcium Carbonate, Ceramic Zirconia, Silicate Mineral, and Minerals for Building Materials Preform Modular alkalines, clays, and sands for fine concrete, mortar, bricks, tiles, and High Wear-Heat Resistant Parts Brushes, Windings, Coils, Battery Cells, Electronic Resistors, Capacitors, Brake Pads, Washers, Spacers, Bushings, Drawn, Annealing, Spun, Coils, Windings, Wire, Woven Textile Mesh, Shielding, And 2.5 phase extrusions Die Cast Molding. Number 5. Supplemental Super Alloy Super Cooling Refrigeration And Super Alloy Venturi Curvical or Linear Expression Comprising a Scientific Aperture, a Divergence Measured in Angulation, and a Scientific Aperture Diffusion Carbon Dioxide CO2 Gaseous Particle Accelerator With Super Cooling Refrigeration Deceleration temperature to less than −109 degrees Fahrenheit or −78.5 degrees Celsius Carbon Dioxide CO2 sublimated frozen gas Supercooling Super Alloy or Super Alloy Venturi. Self-contained Carbon Dioxide CO2 Refrigeration unit used for commercial or residential service operates in a complete vacuum with vacuum pump drawing Carbon Dioxide CO2 gas through insulated Super Alloy feeder tubes in a parallel circuit to separate Super Alloy Venturi Curvical or Linear Expression Comprising a Scientific Aperture, a Divergence Measured in Angulation, and a Scientific Aperture Diffusion Carbon Dioxide CO2 Gaseous Particle Accelerator With Super Cooling Refrigeration Deceleration temperature to less than −109 degrees Fahrenheit or −78.5 degrees Celsius Carbon Dioxide CO2 sublimated frozen gas is then passed over Super Alloy and through cooling fan. Number 6. Distillation and Recovery Basin Variable Hydraulic Press Plate Mold and Carbon Nanofoam CNFs Mold with Pour Aperture located in the center and hydraulic cylinder located on the right Expanded and Contracted for Molten Pouring Highly Pure Metal, Super Alloy including Carbon Nanofoam CNFs, and/or Ceramic for 1.0, and 2.0 phase extrusion Plates, Sheets, Foil, and Leaf Central Processing Unit CPU processor, relay, or switch series or parallel circuit and Battery Cell series or parallel circuit rated conductive Both Having Highly Pure Metal, Super Alloy including Carbon Nanofoam CNfs 1.0 and 2.0 phase extrusion Plates, Sheets, Foil, and Leaf Conductive Super Carbon Alloy Carbon Nanofoam CNFs, Nickel, Cadmium, Lithium, Lead, Antimonide, Halide, Alkalide, Ceramic Silicate Mineral Insulator, and Ceramic Alumina Silica Carbon Nanofoam CNFs. Number 7. Manufacture process of 2.5 phase extrusions Die Cast Molding for Precision Casting of Highly Pure Metal, Super Alloy including Carbon Nanofoam CNFs, and/or Ceramic.
The Highly Pure Metal, Super Alloy including Carbon Nanofoam CNFs, and/or Ceramic is a layered greater than 0% to less than 100% Highly Pure Metal or Super Alloy including Carbon Nanofoam CNFs and greater than 0% to less than 100% Other Metal, Super Alloy including Carbon Nanofoam CNFs or Ceramic part that is created by pouring molten metal or ceramic into a cast mold over a process of 2.5 phase extrusions that create six molded casts for each designed master tool steel part that is manually machined and manufactured named Part X external layer Highly Pure Metal or Super Alloy including Carbon Nanofoam CNFs and Part Z the internal layer other Highly Pure Metal, Super Alloy including Carbon Nanofoam CNFs or Ceramic Insulator.
Manufactured process of 2.5 phase extrusions Die Cast Molding for Precision Casting of Super Alloy and Ceramic ultimately create a single part identical to the master designed and machine manufactured part with the exception to the chemical element is now a Super Alloy or Super Alloy Ceramic that is layered greater than 0% to less than 100% Highly Pure Metal or Super Alloy including Carbon Nanofoam CNFs and greater than 0% to less than 100% Other Highly Pure Metal, Super Alloy including Carbon Nanofoam CNFs and/or Ceramic. Processing molded halves sequence 1 to 9 of Manufacture process of 2.5 phase extrusions Die Cast Molding For Precision Casting of Highly Pure Metal, Super Alloy including Carbon Nanofoam CNFs, and/or Ceramic Part X and Part Z side profile not shown here of casting for Part X two halves sequence 1, side profile not shown here of casting for part Z two halves sequence 2, side profile not shown here of casting for part Z extruded halves sequence 3, cast 1 half of part X sequence 4, cast 3 half of part Z sequence 5, extruded cast 5 half of part Z sequence 6, side profile not shown here of cast 5 on top cast 1 on bottom sequence 7, side profile not shown here of cast 6 on top and cast two on bottom sequence 8, fill halves joined in cast 1 and 2 and filled with molten Highly Pure Metal or Super Alloy including Carbon Nanofoam CNFs sequence 9.
The manufacture process begins by a designed and machined manufactured master part named part X. The master part X is used to create two external cast halves. This is accomplished by casting the master part X into the center of two ceramic molded halves with newly poured ceramic slip. After the ceramic slip dries the master part X is removed and the two ceramic molded halves are ignited and cured in a furnace.
The second master part named part Z is designed and machined manufactured greater than 0% to less than 100% less than tolerances that of the master part X or the external cast halves. Again, the master part Z is used to create two internal cast halves. This is accomplished by casting the master part Z into the center of two ceramic molded halves with newly poured ceramic slip. After the ceramic cast dries the master part Z is removed and the two ceramic molded halves are ignited and cured in a furnace. After the two ceramic cast halves cool they are used separately to make two reciprocal extrusion halves by again pouring ceramic slip into the recesses and joining both halves with new cast covers to dry. The external tolerances of all of the four cast covers X and Z are identical opposing so that X and Z halves can be joined and prepared for two separate halves molten Highly Pure Metal or Super Alloy including Carbon Nanofoam CNFs fills. After the poured molten Highly Pure Metal or Super Alloy including Carbon Nanofoam CNFs cools then both extruded halves are removed and stored. The remainder halves with Highly Pure Metal or Super Alloy including Carbon Nanofoam CNFs are then joined and prepared for a second molten fill of greater than 0% to less than 100% Highly Pure Metal, Super Alloy including Carbon Nanofoam CNFs, and/or Ceramic.
After the fill is cooled the whole part is removed from the cast halves and is inspected, deburred, and/or finished.

2. Utility patent application specification concrete control room and monitoring station manufacturing in a complete vacuum and may supply rich oxygen from capillary feeders at varying points to utility patent application specification for with die cast mold extrusion or printing hot smelters, crucibles casting, and 2.5 phase die mold extrusion manufacturing of specified highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator six master extrusion halves 2.5 phase extrusions per specification part molten foundry fill four pours, and the manufacture process or assembly for each specification component or part thereof parts may be sprayed and dipped non conductive adhesives insulator films and all waste gases are processed to flu gas detoxification system. Number 8. Utility patent application specification concrete control room and monitoring station manufacturing in a complete vacuum and may supply rich oxygen from capillary feeders at varying points to utility patent application specification manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component, or other metal drawing and annealing process for Wire, spun Cable, Rebar textile Mesh, with or without woven textile synthetic resin or natural fibers unit of measurement in gage Rebar Cable or Manufacture Process Connector System, cable connectors, powders, nitrate hardened or non hardened Nitride Steel Grit unit of measurement in mesh or grit size and manufacturing of carbon nanofoam CNFs Super Alloy Super Carbon Alloy. Number 9. Utility patent application specification concrete control room and monitoring station manufacturing in a complete vacuum and may supply rich oxygen from capillary feeders at varying points to utility patent application specification 2.5 phase extrusions manufacturing of highly pure metal or Super Alloy precision casting of airframe, bearings, and assemblies, motor casings, aircraft landing gear, turbine blades, assemblies, and housings parts may be sprayed and dipped non conductive adhesives insulator films and all waste gases are processed to flu gas detoxification system. Number 10. Utility patent application specification concrete control room and monitoring station manufacturing in a complete vacuum and may supply rich oxygen from capillary feeders at varying points to highly pure metal copper pre and post foundry mechanically refined copper ore anticorrosive treatment chemical submersion bath sodium, tolyltriazole, and methyl, benziotriole flake and prill washing and screening tables and chemical submersion bath techniques are utilized and in manufacturing of highly pure other metals mechanically refined ore iron, molybdenum, aluminum, zinc, zirconium, titanium, tungsten, or metal pre and post foundry anticorrosive treatment chemical submersion bath hydrochloric acid, ammonia from nitrogen, and hydrogen anticorrosive purification treatment and all waste gases are processed to flu gas detoxification system. Number 11. Utility patent application specification concrete control room and monitoring station manufacturing in a complete vacuum and may supply rich oxygen from capillary feeders at varying points to mechanically refined metal ore sintered and smeltered nonmetallic additive carbon nanofoam CNFs alloyed Super Carbon Alloy, steel Super Carbon Steel, tungsten Super Carbon Tungsten, or additive sintered and smeltered molybdenum for homogenization steel Molybdenum Steel, or tungsten Molybdenum Tungsten and all waste gases are processed to flu gas detoxification system. Number 12. Utility patent application specification manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator 2.5 phase extrusions or half shell casted composite coils, composite windings, drawn, annealing, spun, coils, windings, wire, woven textile mesh, shielding, brushes, inductors, antinode couplers, electric rheostats, starters, motors, alternators, generators, ionic suspension element enhanced composite coils, composite windings, drawn, annealing, spun, coils, windings, wire, woven textile mesh, shielding, brushes, capacitors, battery cells, rheostats, or electronic parts, electronic resistors, or electronic parts, transformers, transducers, rectifiers, power supplies, heat sinks, or electronic parts highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor six sides rectangle, or square, or three sides continuous rod or cylinder highly pure metal, Super Alloy, acid solid, alkaline, glass, acrylic, halide, alkalide, non conductive zirconia, impedance matching load or signal ceramic red brick clay insulator, carbon nanofoam CNFs, or alternate carbon nanofoam CNFs inductor, or three sides zircon cutting tools, or two sides continuous for drill bits half shell casted tools measured in gage. Number 13. Utility patent application specification concrete control room and monitoring station manufacturing in a complete vacuum and may supply rich oxygen from capillary feeders at varying points to utility patent application specification manufacturing of highly pure metal, Super Alloy, ceramics, acid solid, alkaline, glass, acrylic, halide, alkalide, nonconductive zirconia, carbon nanofoam CNFs, alternate carbon nanofoam CNFs inductor, or impedance matching load or signal ceramic red brick clay insulator hot pouring casting printing with molten foundry fill of die cast mold precision casting of bars, rods, plates, sheets, foil, leaf, copper wire, drawing, annealing, and spun coils and windings for electronic component or other metal drawing and annealing process for Wire, and spun Cable, Rebar textile Mesh, with or without woven textile synthetic resin or natural fibers unit of measurement in gage Rebar Cable or Manufacture Process Connector System, cable connectors, powders, nitrate hardened or non hardened Nitride Steel Grit unit of measurement in mesh or grit size and manufacturing of carbon nanofoam CNFs Super Alloy Super Carbon Alloy. Number 14. Utility patent application specification manufacture process of replacement ceramic precision casting molds specification number 27 for with manufacturing highly pure metal, Super Alloy, acid solid, alkaline, glass, acrylic, halide, alkalide, nonconductive zirconia, impedance matching load or signal ceramic red brick clay insulator, carbon nanofoam CNFs, or alternate carbon nanofoam CNFs inductor. Number 15. Utility patent application specification manufacture process of preform slurry non ionic or electrolyte carbon nanofoam CNFs with or without ionic suspension element specification 46 elements or specification 47 alloys extrusion or casted highly pure metal, Super Alloy, carbon nanofoam CNFs with or without ionic suspension element specification 46 elements or specification 47 alloys, and alkaline, glass, acrylic, halide, alkalide, nonconductive zirconia, or impedance matching load or signal ceramic red brick clay insulator casted electronic part equivalent to one composite coil, composite winding, battery cell, capacitor, and brush one, or more gradated in even intervals of electric rheostat, battery, starter, motor, alternator, generator, transformer, transducer, rectifier, power supply, junction box, or heat sink in series or parallel circuit two positive and negative +/− terminals measured in Volts symbol V, or of preform slurry non ionic or electrolyte alternate carbon nanofoam CNFs inductor extrusion, or casted highly pure metal, Super Alloy, alternate carbon nanofoam CNFs inductor, nonconductive zirconia, and impedance matching load or signal ceramic red brick clay insulator electronic part equivalent to one resistor, switch, relay, or electronic part inductor, antinode coupler, and ground in series or parallel circuit two negative −/− terminals measure in Ohms symbol Ω of inductor, antinode coupler, and ground or two positive and negative +/− terminals measured in Volts symbol V. All electronic parts two sides casted conductive plate, sheet, foil, or leaf highly pure metal, Super Alloy, or alkalide rectangle, square, continuous rod or cylinder. Rectangle or square six sides, five sides nonconductive zirconia, impedance matching load or signal ceramic red brick clay insulator, carbon nanofoam CNFs, or alternate carbon nanofoam CNFs inductor, plate, sheet, foil, or leaf casted insulated, and one side layered or non layered conductive highly pure metal, Super Alloy, and/or alkaline, glass, acrylic, halide, or alkalide, plate, sheet, foil, or leaf casted conductive, or four sides nonconductive zirconia, impedance matching load or signal ceramic red brick clay insulator, carbon nanofoam CNFs, or alternate carbon nanofoam CNFs inductor casted plate, sheet, foil, or leaf insulated, and two conductive highly pure metal, Super Alloy, and/or alkaline, glass, acrylic, halide, or alkalide, plate, sheet, foil, or leaf casted in series or parallel circuit and two positive and negative +/− terminals measured in Volts symbol V or two negative −/− terminals measured in Ohms symbol Ω to antinode coupler, or continuous rod or cylinder three sides, one continuous side nonconductive zirconia, impedance matching load or signal ceramic red brick clay insulator, carbon nanofoam CNFs, or alternate carbon nanofoam CNFs inductor, plate, sheet, foil, or leaf casted insulated, and two sides conductive highly pure metal, Super Alloy, and/or alkaline, glass, acrylic, halide, or alkalide, plate, sheet, foil, or leaf casted in series or parallel circuit and two positive and negative +/− terminals measured in Volts symbol V or two negative −/− terminals measured in Ohms symbol Ω to antinode coupler preform slurry non ionic or electrolyte casted ionic suspension element carbon nanofoam CNFs battery cell outstanding one or two sides plate, sheet, foil, or leaf casted conductive highly pure metal, Super Alloy, or alkalide in series or parallel circuit and two positive and negative +/− terminals measured in Volts symbol V or two negative −/− terminals measured in Ohms symbol Ω to antinode coupler or electronic parts requires one, or two, or more brushes in even intervals and two or more inductors and antinode couplers with one or two sides conductive plate, sheet, foil, or leaf casted highly pure metal, Super Alloy, or alkalide in series or parallel circuit and two positive and negative +/− terminals measured in Volts symbol V or two negative −/− terminals measured in Ohms symbol Ω to antinode coupler. Number 16. Battery crucible casted or 2.5 phase extrusions highly pure metal or Super Alloy battery cells layered, spaced and casted conductive in series or parallel circuit even or odd interval number combinations varying complex, battery cells highly pure acid solid chemical and/or highly pure chemical alkali solid complex, crucible casted conductive or 2.5 phase extrusions highly pure metal or Super Alloy layered and interval spaced conductive in series or parallel circuit. Battery with or without lightweight super impregnated suspension element Halogen, or Antimony, or Chemical Element-gases ammonia, nitrogen, hydrogen, hydrochloric acid with or without ionic suspension element carbon nanofoam CNFs, Nano alumina, and ionic suspension element specification 46 highly pure metals or ionic suspension element specification 47 Super Alloys and/or Alumina, crucible casted conductive or 2.5 phase extrusions highly pure metal or Super Alloy layered, and interval spaced series or parallel circuit and/or complex, crucible casted conductive or 2.5 phase extrusions Variable hydraulic preform slurry non ionic silica alumina carbon nanofoam CNFs extrusion high wear-heat compression resistant light weight battery cells. Highly pure alkali silica, alumina Nano alumina, or elements lithium, cadmium, nickel, lead, copper, specification 46 elements or specification 47 alloys. One by one each battery cell crucible casted non conductive or submersion bath sealed Thermoplastic resin composition and its synthetic resin composite polymer insulation control room vacuum protocol manufacture process. Motor Frame protected of four woven synthetic resin fiber textile mesh, silica resin fiber heat resistant textile mesh, Variable hydraulic preform slurry non ionic silica alumina carbon nanofoam CNFs extrusion high wear-heat compression resistant light weight insulator, and/or high tensile strength shielded textile Super Carbon Alloy. One by one each battery cell crucible casted or submersion bath sealed Thermoplastic resin composition and its synthetic resin composite polymer insulator control room vacuum protocol manufacture process. All four conductive or nonconductive heat-wear high tensile strength and compression resistant insulators are designed and built in Monocomb and corrugated—compartmented composite combinations Thermoplastic sealed, layered or woven shielded. Number 17. Motor crucible casted or 2.5 phase extrusions highly pure metal or Super Alloy composite coils; composite windings, and copper wire drawing, annealing, and spun coils or other highly pure metal including highly pure metal or Super Alloy drawing and annealing process for wire. Motors composite coils, composite windings usually copper or Super Alloy includes continuous or numeric interval spools shapes of rod, cylinder, sphere, rectangle, or square crucible casted or 2.5 phase extrusions. Motor electronic components brushes Carbon Nanofoam CNFs with or without ionic suspension elements each brush alternate carbon nanofoam inductors, and antinode coupler continuous or numeric ramps positive and negative terminal +/− measured in volts V and monitors positive and negative terminal +/− measured in volts V and negative and negative −/− terminals measure in Ohms symbol Ω of inductor, antinode coupler, and ground series or parallel circuit. Spun numeric wrapped copper or Super Carbon Copper Alloy wire are Thermoplastic dipped or woven protected synthetic resin fibers, silica woven resin fibers or high tensile strength Super Alloy carbon nanofoam CNFs shielding. Motor frame protected of three woven synthetic resin fiber textile shielding, silica resin fiber high heat-resistant insulator textile shielding, and/or high tensile strength textile Super Carbon Alloy shielding. One by one all composite or wire Motor coils and windings are crucible casted or submersion bath sealed Thermoplastic resin composition and its synthetic resin composite polymer insulator control room vacuum protocol manufacture process. Three heat-wear high tensile strength and Variable hydraulic preform slurry non ionic silica alumina carbon nanofoam CNFs extrusion high wear-heat compression resistant light weight insulators are designed and built in Monocomb and corrugated—compartmented composite combinations Thermoplastic sealed, layered or woven shielded. Crucible casted or 2.5 phase extrusions motor casings, rods, bearings, housings, and assemblies are manufactured and assembled.

3. Spectrometry processor for commercial sale comprises scientific 10 inch camera spectrometry lens conveying light to specialized mirror and/or active chemical film and reflected onto red, green, and blue RGB scale trade name pixilated lenses conveying light to fiber optic cables conveying light to Central Processing Unit CPU processors electronic photo receptors frequency counters of red, green, or blue RGB scale signals output and/or Central Processing Unit CPU processors or red, green, and blue RGB scale signals output to Central Processing Unit CPU processors monitor and/or Central Processing Unit CPU processors super alloy rasterized of red, green, and blue RGB scale ink composite printed film.
